(19) United States
(12) Patent Application Publication
(10) Pub. No.: US 2023/0196063 A1
(43) Pub. Date: Jun. 22, 2023

(54) ARTIFICIAL INTELLIGENCE DEVELOPMENT AND UPGRADING USING A NEURO-SYMBOLIC METAMODEL

(71) Applicant: Cisco Technology, Inc., San Jose, CA (US)

(72) Inventors: Hugo Latapie, Long Beach, CA (US); Ozkan Kilic, Long Beach, CA (US); Adam James Lawrence, Pasadena, CA (US); Gaowen Liu, Austin, TX (US); Andrew Albert Pletcher, Scotts Valley, CA (US)

(21) Appl. No.: 17/557,734

(22) Filed: Dec. 21, 2021

(51) Int. Cl. G06N 3/04

(52) U.S. Cl. CPC G06N 3/04

(57) ABSTRACT

In one embodiment, a device obtains data regarding generation of an artificial intelligence model. The device analyzes the data using a neuro-symbolic metamodel, to match the data to one or more concepts of a knowledge graph of the neuro-symbolic metamodel. The device makes one or more inferences about the artificial intelligence model, by applying a semantic reasoning engine to the one or more concepts of the knowledge graph. The device causes, based on the one or more inferences, generation of a replacement artificial intelligence model for the artificial intelligence model.

### TECHNICAL FIELD

The present disclosure relates generally to computer networks, and, more particularly, to artificial intelligence development and upgrading using a neuro-symbolic metamodel.

### BACKGROUND

Artificial intelligence continues to grow in both its capabilities as well as how it is used. Indeed, artificial intelligence is now used for tasks such as classification and prediction, across a large number of use cases. In addition, the variety of artificial intelligence techniques also continues to grow, such as neural networks, random forests, etc.

Unfortunately, training an artificial intelligence model is not an easy endeavor and is fraught with potential pitfalls. For this reason, the majority of artificial intelligence projects fail due to factors such as under specification of the problem, poor ability to generalize, expensive training cycles, and the like. Even when an artificial intelligence model is deployed, it is unlikely to be optimized for its intended use.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example computer network;

FIG. 2 illustrates an example network device/node;

FIG. 3 illustrates an example hierarchy for a deep fusion reasoning engine (DFRE);

FIG. 4 illustrates an example DFRE architecture;

FIG. 5 illustrates an example of various inference types;

FIG. 6 illustrates an example architecture for multiple DFRE agents;

FIG. 7 illustrates an example DFRE metamodel;

FIG. 8 illustrates an example of using a DFRE metamodel to upgrade artificial intelligence models;

FIG. 9 illustrates an example user interface to modify a knowledge graph; and

FIG. 10 illustrates an example simplified procedure for artificial intelligence development and upgrading using a neuro-symbolic metamodel.

### DESCRIPTION OF EXAMPLE EMBODIMENTS

Overview

According to one or more embodiments of the disclosure, a device obtains data regarding generation of an artificial intelligence model. The device analyzes the data using a neuro-symbolic metamodel, to match the data to one or more concepts of a knowledge graph of the neuro-symbolic metamodel. The device makes one or more inferences about the artificial intelligence model, by applying a semantic reasoning engine to the one or more concepts of the knowledge graph. The device causes, based on the one or more inferences, generation of a replacement artificial intelligence model for the artificial intelligence model.

### DESCRIPTION

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

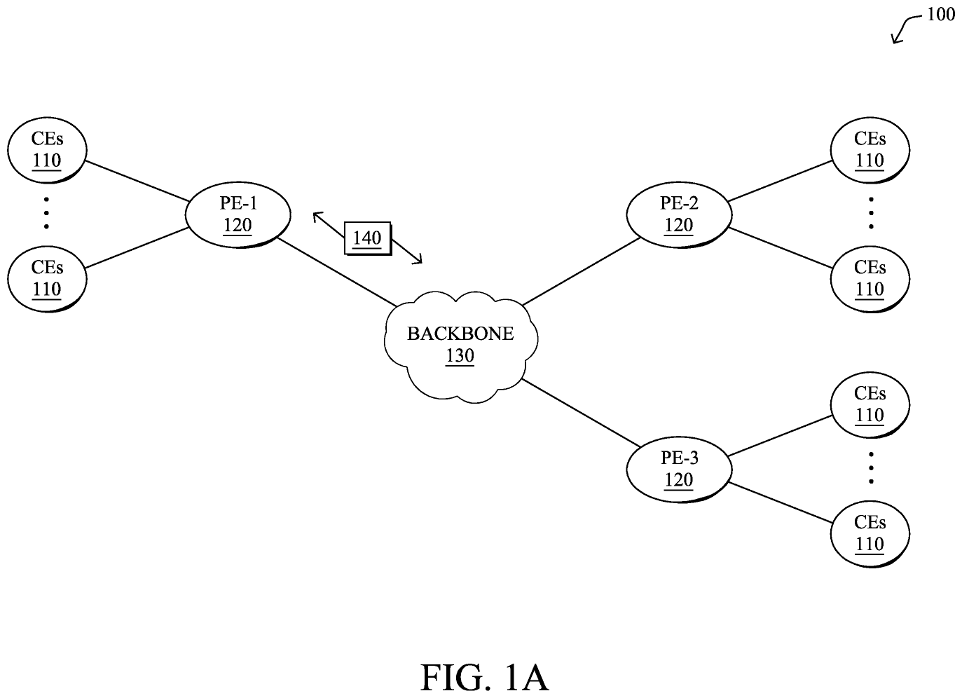

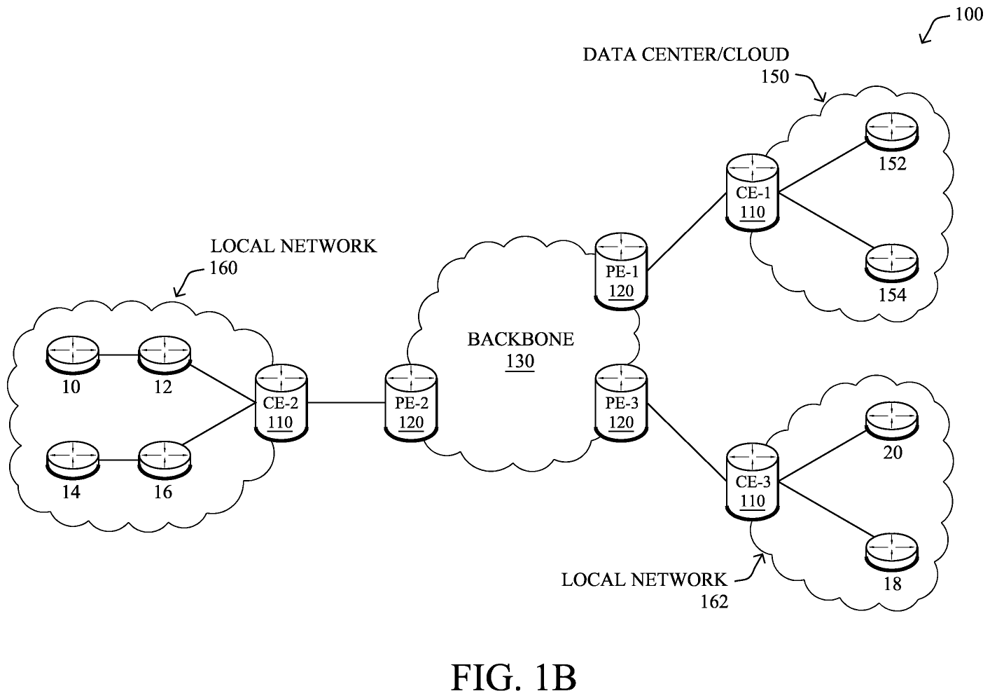

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for devices/nodes 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

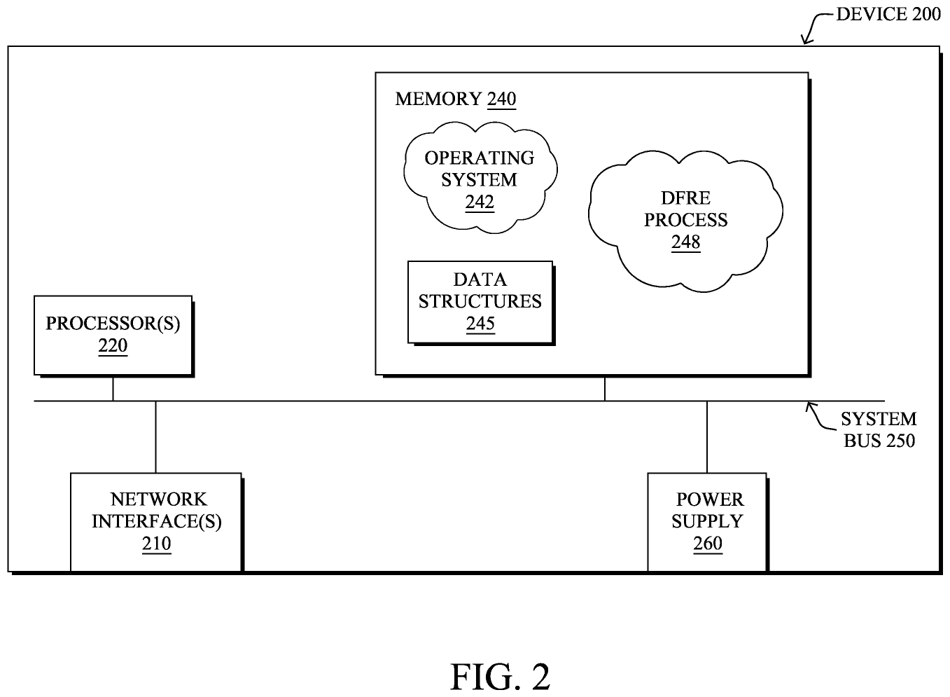

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a deep fusion reasoning engine (DFRE) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

DFRE process 248 includes computer executable instructions that, when executed by processor(s) 220, cause device 200 to provide cognitive reasoning services to a network. In various embodiments, DFRE process 248 may utilize artificial intelligence/machine learning techniques, in whole or in part, to perform its analysis and reasoning functions. In general, machine learning is concerned with the design and the development of techniques that take as input empirical data (such as network statistics and performance indicators) and recognize complex patterns in these data. One very common pattern among machine learning techniques is the use of an underlying model M, whose hyper-parameters are optimized for minimizing the cost function associated to M, given the input data. The learning process then operates by adjusting the hyper-parameters such that the number of misclassified points is minimal. After this optimization phase (or learning phase), the model M can be used very easily to classify new data points. Often, M is a statistical model, and the minimization of the cost function is equivalent to the maximization of the likelihood function, given the input data.

In various embodiments, DFRE process 248 may employ one or more supervised, unsupervised, or self-supervised machine learning models. Generally, supervised learning entails the use of a training large set of data, as noted above, that is used to train the model to apply labels to the input data. For example, in the case of video recognition and analysis, the training data may include sample video data that depicts a certain object and is labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Self-supervised is a representation learning approach that eliminates the pre-requisite requiring humans to label data. Self-supervised learning systems extract and use the naturally available relevant context and embedded metadata as supervisory signals. Self-supervised learning models take a middle ground approach: it is different from unsupervised learning as systems do not learn the inherent structure of data, and it is different from supervised learning as systems learn entirely without using explicitly-provided labels.

Example machine learning techniques that DFRE process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. Accordingly, DFRE process 248 may employ deep learning, in some embodiments. Generally, deep learning is a subset of machine learning that employs ANNs with multiple layers, with a given layer extracting features or transforming the outputs of the prior layer.

The performance of a machine learning model can be evaluated in a number of ways based on the number of true positives, false positives, true negatives, and/or false negatives of the model. For example, the false positives of the model may refer to the number of times the model incorrectly identified an object or condition within a video feed. Conversely, the false negatives of the model may refer to the number of times the model failed to identify an object or condition within a video feed. True negatives and positives may refer to the number of times the model correctly determined that the object or condition was absent in the video or was present in the video, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

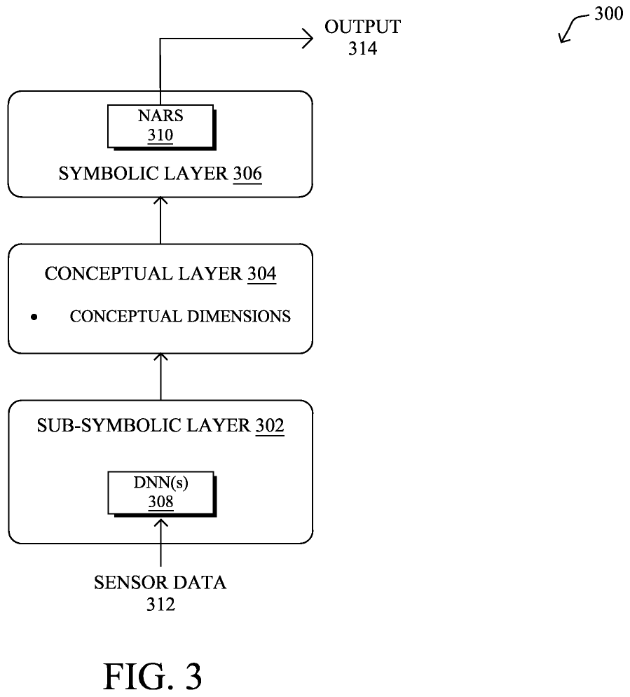

According to various embodiments, FIG. 3 illustrates an example hierarchy 300 for a deep fusion reasoning engine (DFRE). For example, DFRE process 248 shown in FIG. 2 may execute a DFRE for any number of purposes. In particular, DFRE process 248 may be configured to analyze sensor data in an IoT deployment (e.g., video data, etc.), to analyze networking data for purposes of network assurance, control, enforcing security policies and detecting threats, facilitating collaboration, or, as described in greater detail below, to aid in the development of a collaborative knowledge generation and learning system for visual programming.

In general, a reasoning engine, also known as a ‘semantic reasoner,’ reasoner,′ or ‘rules engine,’ is a specialized form of machine learning software that uses asserted facts or axioms to infer consequences, logically. Typically, a reasoning engine is a form of inference engine that applies inference rules defined via an ontology language. As introduced herein, a DFRE is an enhanced form of reasoning engine that further leverages the power of sub-symbolic machine learning techniques, such as neural networks (e.g., deep learning), allowing the system to operate across the full spectrum of sub-symbolic data all the way to the symbolic level.

At the lowest layer of hierarchy 300 is sub-symbolic layer 302 that processes the sensor data 312 collected from the network. For example, sensor data 312 may include video feed/stream data from any number of cameras located throughout a location. In some embodiments, sensor data 312 may comprise multimodal sensor data from any number of different types of sensors located throughout the location. At the core of sub-symbolic layer 302 may be one or more DNNs 308 or other machine learning-based model that processes the collected sensor data 312. In other words, sub-symbolic layer 302 may perform sensor fusion on sensor data 312 to identify hidden relationships between the data.

At the opposing end of hierarchy 300 may be symbolic layer 306 that may leverage symbolic learning. In general, symbolic learning includes a set of symbolic grammar rules specifying the representation language of the system, a set of symbolic inference rules specifying the reasoning competence of the system, and a semantic theory containing the definitions of “meaning.” This approach differs from other learning approaches that try to establish generalizations from facts as it is about reasoning and extracting knowledge from knowledge. It combines knowledge representations and reasoning to acquire and ground knowledge from observations in a non-axiomatic way. In other words, in sharp contrast to the sub-symbolic learning performed in layer 302, the symbolic learning and generalized intelligence performed at symbolic layer 306 requires a variety of reasoning and learning paradigms that more closely follows how humans learn and are able to explain why a particular conclusion was reached.

Symbolic learning models what are referred to as “concepts,” which comprise a set of properties. Typically, these properties include an “intent” and an “extent,” whereby the intent offers a symbolic way of identifying the extent of the concept. For example, consider the intent that represents motorcycles. The intent for this concept may be defined by properties such as “having two wheels” and “motorized,” which can be used to identify the extent of the concept (e.g., whether a particular vehicle is a motorcycle).

Linking sub-symbolic layer 302 and symbolic layer 306 may be conceptual layer 304 that leverages conceptual spaces. In general, conceptual spaces are a proposed framework for knowledge representation by a cognitive system on the conceptual level that provides a natural way of representing similarities. Conceptual spaces enable the interaction between different type of data representations as an intermediate level between sub-symbolic and symbolic representations.

More formally, a conceptual space is a geometrical structure which is defined by a set of quality dimensions to allow for the measurement of semantic distances between instances of concepts and for the assignment of quality values to their quality dimensions, which correspond to the properties of the concepts. Thus, a point in a conceptual space S may be represented by an n-dimensional conceptual vector v=<d₁, . . . , dᵢ, . . . , dₙ>where dᵢ represents the quality value for the i^{th} quality dimension. For example, consider the concept of taste. A conceptual space for taste may include the following dimensions: sweet, sour, bitter, and salty, each of which may be its own dimension in the conceptual space. The taste of a given food can then be represented as a vector of these qualities in a given space (e.g., ice cream may fall farther along the sweet dimension than that of peanut butter, peanut butter may fall farther along the salty dimension than that of ice cream, etc.). By representing concepts within a geometric conceptual space, similarities can be compared in geometric terms, based on the Manhattan distance between domains or the Euclidean distance within a domain in the space. In addition, similar objects can be grouped into meaningful conceptual space regions through the application of clustering techniques, which extract concepts from data (e.g., observations).

Said differently, a conceptual space is a framework for representing information that models human-like reasoning to compose concepts using other existing concepts. Note that these representations are not competing with symbolic or associationistic representations. Rather, the three kinds can be seen as three levels of representations of cognition with different scales of resolution and complementary. Namely, a conceptual space is built up from geometrical representations based on a number of quality dimensions that complements the symbolic and deep learning models of symbolic layer 306 and sub-symbolic layer 302, representing an operational bridge between them. Each quality dimension may also include any number of attributes, which present other features of objects in a metric subspace based on their measured quality values. Here, similarity between concepts is just a matter of metric distance between them in the conceptual space in which they are embedded.

In other words, a conceptual space is a geometrical representation which allows the discovery of regions that are physically or functionally linked to each other and to abstract symbols used in symbolic layer 306, allowing for the discovery of correlations shared by the conceptual domains during concepts formation. For example, an alert prioritization module may use connectivity to directly acquire and evaluate alerts as evidence. Possible enhancements may include using volume of alerts and novelty of adjacent (spatially/temporally) alerts, to tune level of alertness.

In general, the conceptual space at conceptual layer 304 allows for the discovery of regions that are naturally linked to abstract symbols used in symbolic layer 306. The overall model is bi-directional as it is planned for predictions and action prescriptions depending on the data causing the activation in sub-symbolic layer 302.

Layer hierarchy 300 shown is particularly appealing when matched with the attention mechanism provided by a cognitive system that operates under the assumption of limited resources and time-constraints. For practical applications, the reasoning logic in symbolic layer 306 may be non-axiomatic and constructed around the assumption of insufficient knowledge and resources (AIKR). It may be implemented, for example, with a Non-Axiomatic Reasoning System (open-NARS) 310. However, other reasoning engines can also be used, such as Auto-catalytic Endogenous Reflective Architecture (AERA), OpenCog, and the like, in symbolic layer 306, in further embodiments. Even Prolog may be suitable, in some cases, to implement a reasoning engine in symbolic layer 306. In turn, an output 314 coming from symbolic layer 306 may be provided to a user interface (UI) for review. For example, output 314 may comprise a video feed/stream augmented with inferences or conclusions made by the DFRE, such as the locations of unstocked or under-stocked shelves, etc.

By way of example of symbolic reasoning, consider the ancient Greek syllogism: (1.) All men are mortal, (2.) Socrates is a man, and (3.) therefore, Socrates is mortal. Depending on the formal language used for the symbolic reasoner, these statements can be represented as symbols of a term logic. For example, the first statement can be represented as “man→[mortal]” and the second statement can be represented as “{Socrates}→man.” Thus, the relationship between terms can be used by the reasoner to make inferences and arrive at a conclusion (e.g., “Socrates is mortal”). Non-axiomatic reasoning systems (NARS) generally differ from more traditional axiomatic reasoners in that the former applies a truth value to each statement, based on the amount of evidence available and observations retrieved, while the latter relies on axioms that are treated as a baseline of truth from which inferences and conclusions can be made.

Thus, a DFRE generally refers to a cognitive engine capable of taking sub-symbolic data as input (e.g., raw or processed sensor data regarding a monitored system), recognizing symbolic concepts from that data, and applying symbolic reasoning to the concepts, to draw conclusions about the monitored system.

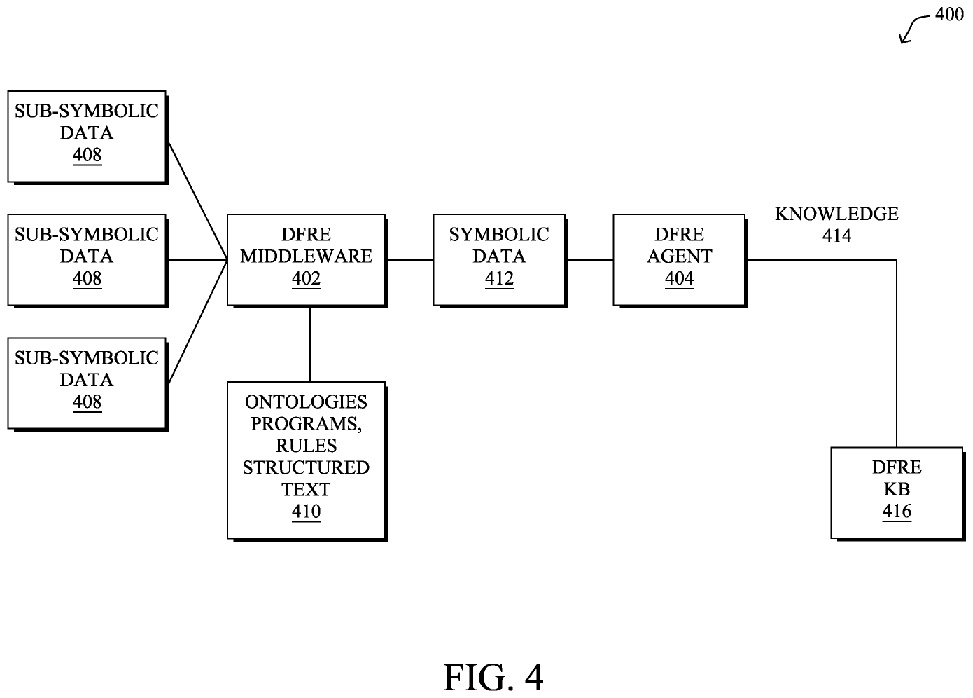

According to various embodiments, FIG. 4 illustrates an example DFRE architecture 400. As shown, architecture 400 may be implemented across any number of devices or fully on a particular device, as desired. At the core of architecture 400 may be DFRE middleware 402 that offers a collection of services, each of which may have its own interface. In general, DFRE middleware 402 may leverage a library for interfacing, configuring, and orchestrating each service of DFRE middleware 402.

In various embodiments, DFRE middleware 402 may also provide services to support semantic reasoning, such as by an AIKR reasoner. For example, as shown, DFRE middleware 402 may include a NARS agent that performs semantic reasoning for structural learning. In other embodiments, OpenCog or another suitable AIKR semantic reasoner could be used.

One or more DFRE agents 404 may interface with DFRE middleware 402 to orchestrate the various services available from DFRE middleware 402. In addition, DFRE agent 404 may feed and interact with the AIKR reasoner so as to populate and leverage a DFRE knowledge graph with knowledge.

More specifically, in various embodiments, DFRE middleware 402 may obtain sub-symbolic data 408. In turn, DFRE middleware 402 may leverage various ontologies, programs, rules, and/or structured text 410 to translate sub-symbolic data 408 into symbolic data 412 for consumption by DFRE agent 404. This allows DFRE agent 404 to apply symbolic reasoning to symbolic data 412, to populate and update a DFRE knowledge base (KB) 416 with knowledge 414 regarding the problem space (e.g., the network under observation, etc.). In addition, DFRE agent 404 can leverage the stored knowledge 414 in DFRE KB 416 to make assessments/inferences.

For example, DFRE agent 404 may perform semantic graph decomposition on DFRE KB 416 (e.g., a knowledge graph), so as to compute a graph from the knowledge graph of KB 416 that addresses a particular problem. DFRE agent 404 may also perform post-processing on DFRE KB 416, such as performing graph cleanup, applying deterministic rules and logic to the graph, and the like. DFRE agent 404 may further employ a definition of done, to check goals and collect answers using DFRE KB 416.

In general, DFRE KB 416 may comprise any or all of the following:
Data
Ontologies
Evolutionary steps of reasoning
   Knowledge (e.g., in the form of a knowledge graph)
   The Knowledge graph also allows different reasoners to:
      Have their internal subgraphs
      Share or coalesce knowledge
      Work cooperatively

In other words, DFRE KB 416 acts as a dynamic and generic memory structure. In some embodiments, DFRE KB 416 may also allow different reasoners to share or coalesce knowledge, have their own internal sub-graphs, and/or work collaboratively in a distributed manner. For example, a first DFRE agent 404 may perform reasoning on a first sub-graph, a second DFRE agent 404 may perform reasoning on a second sub-graph, etc., to evaluate the health of the network and/or find solutions to any detected problems. To communicate with DFRE agent 404, DFRE KB 416 may include a bidirectional Narsese interface or other interface using another suitable grammar.

In various embodiments, DFRE KB 416 can be visualized on a user interface. For example, Cytoscape, which has its building blocks in bioinformatics and genomics, can be used to implement graph analytics and visualizations.

Said differently, DFRE architecture 400 may include any or all of the following the following components:
DFRE middleware 402 that comprises:
   Structural learning component
   JSON, textual data, ML/DL pipelines, and/or other containerized services (e.g., using Docker)
   Hierarchical goal support
DFRE Knowledge Base (KB) 416 that supports:
   Bidirectional Narseseese interface
   Semantic graph decomposition algorithms
   Graph analytics
   Visualization services
DFRE Agent 404
   DFRE Control System

More specifically, in some embodiments, DFRE middleware 402 may include any or all of the following:
Subsymbolic services:
   Data services to collect sub-symbolic data for consumption
Reasoner(s) for structural learning
NARS
OpenCog
Optimized hierarchical goal execution
   Probabilistic programming
   Causal inference engines
Visualization Services (e.g., Cytoscape, etc.)

DFRE middleware 402 may also allow the addition of new services needed by different problem domains.

During execution, DFRE agent 404 may, thus, perform any or all of the following:
Orchestration of services
Focus of attention
   Semantic graph decomposition
      Addresses combinatorial issues via an automated divide and conquer approach that works even in non-separable problems because the overall knowledge graph 416 may allow for overlap.
Feeding and interacting with the AIKR reasoner via bidirectional translation layer to the DFRE knowledge graph.
   Call middleware services
Post processing of the graph
   Graph clean-up
   Apply deterministic rules and logic to the graph
Definition of Done (DoD)
   Check goals and collect answers

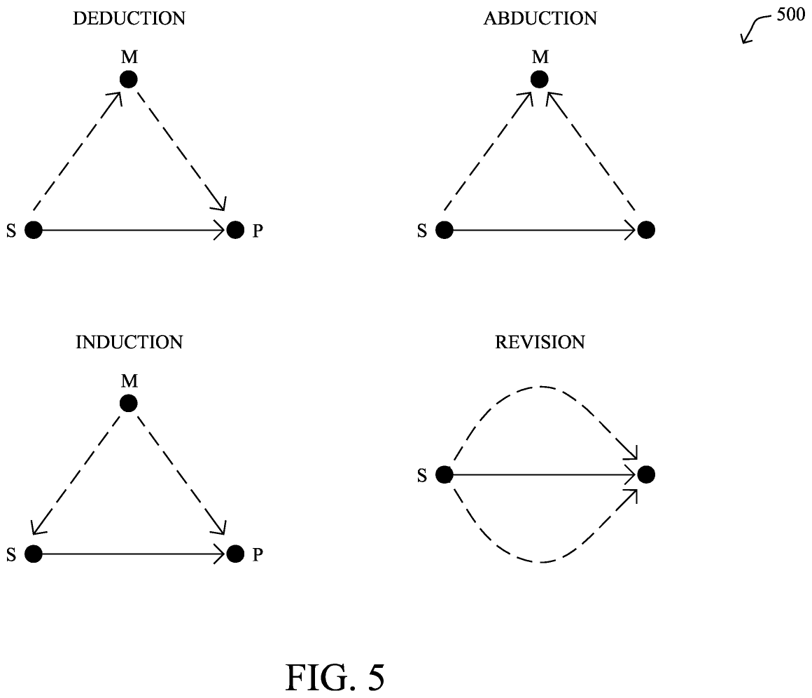

FIG. 5 illustrates an example 500 showing the different forms of structural learning that the DFRE framework can employ. More specifically, the inference rules in example 500 relate premises SM and MP, leading to a conclusion SP. Using these rules, the structural learning herein can be implemented using an ontology with respect to an Assumption of Insufficient Knowledge and Resources (AIKR) reasoning engine, as noted previously. This allows the system to rely on finite processing capacity in real time and be prepared for unexpected tasks. More specifically, as shown, the DFRE may support any or all of the following:
Syllogistic Logic
   Logical quantifiers
Various Reasoning Types
   Deduction Induction
   Abduction
   Induction
   Revision
Different Types of Inference
Local inference
Backward inference

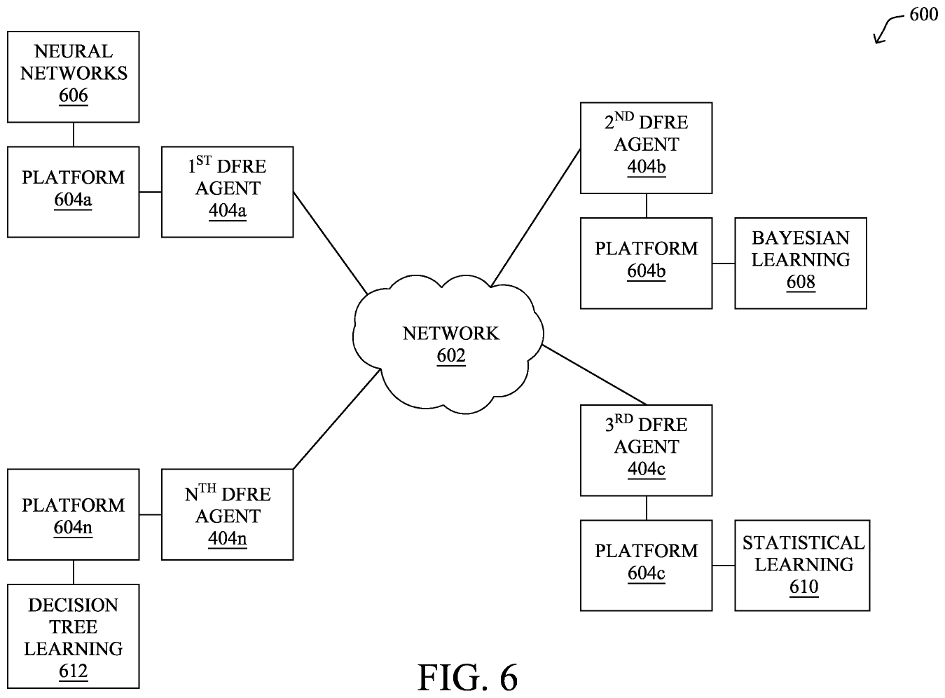

To address combinatorial explosion, the DFRE knowledge graph may be partitioned such that each partition is processed by one or more DFRE agents 404, as shown in architecture 600 in FIG. 6, in some embodiments. More specifically, any number of DFRE agents 404 (e.g., a first DFRE agent 404a through an N^{th} DFRE agent 404n) may be executed by devices connected via a network 602 or by the same device. In some embodiments, DFRE agents 404a-404n may be deployed to different platforms (e.g., platforms 604a-604n) and/or utilize different learning approaches. For instance, DFRE agent 404a may leverage neural networks 606, DFRE agent 404b may leverage Bayesian learning 608, DFRE agent 404c may leverage statistical learning, and DFRE agent 404n may leverage decision tree learning 612.

As would be appreciated, graph decomposition can be based on any or all of the following:
Spatial relations—for instance, this could include the vertical industry of a customer, physical location (country) of a network, scale of a network deployment, or the like.
Descriptive properties, such as severity, service impact, next step, etc.
Graph-based components (isolated subgraphs, minimum spanning trees, all shortest paths, strongly connected components . . . )
   Any new knowledge and related reasoning steps can also be input back to the knowledge graph, in various embodiments.

In further embodiments, the DFRE framework may also support various user interface functions, so as to provide visualizations, actions, etc. to the user. To do so, the framework may leverage Cytoscape, web services, or any other suitable mechanism.

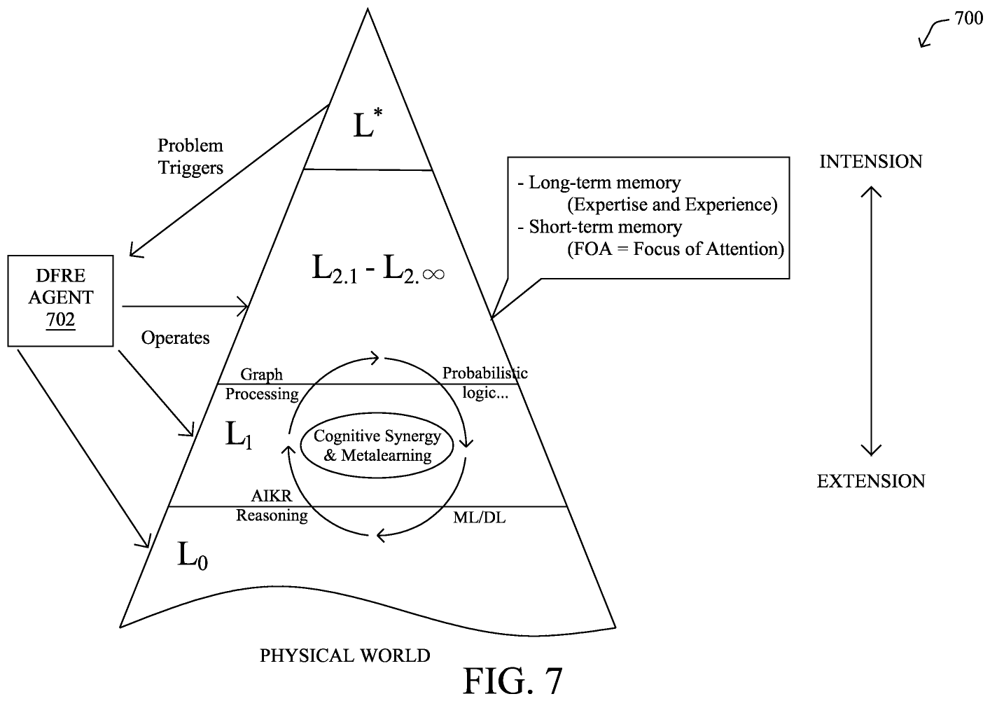

At the core of the techniques herein is an artificial intelligence metamodel 700 for knowledge representation at different levels of abstraction, as shown in FIG. 7, according to various embodiments. In various embodiments, the DFRE knowledge graph groups information into four different levels, which are labeled L₀, L₁, L₂, and L* and represent different levels of abstraction, with L₀ being closest to raw data coming in from various sensors and external systems and L₂ representing the highest levels of abstraction typically obtained via mathematical means such as statistical learning and reasoning. L* can be viewed as the layer where high-level goals and motivations are stored. The overall structure of this knowledge is also based on anti-symmetric and symmetric relations.

One key advantage of the DFRE knowledge graph is that human level domain expertise, ontologies, and goals are entered at the L₂ level. This leads, by definition, to an unprecedented ability to generalize at the L₂ level thus minimizing the manual effort required to ingest domain expertise.

More formally:
L* represents the overall status of the abstraction. In case of a problem, it triggers problem solving in lower layers via a DFRE agent 702.
L_{2.1}-L_{2.∞}=Higher level representations of the world in which most of concepts and relations are collapsed into simpler representations. The higher-level representations are domain-specific representations of lower levels.
L₁=has descriptive, teleological and structural information about L₀.
L₀=Object level is the symbolic representation of the physical world.

In various embodiments, L₂ may comprise both expertise and experience stored in long-term memory, as well as a focus of attention (FOA) in short-term memory. In other words, when a problem is triggered at L*, a DFRE agent 702 that operates on L₂-L₀ may control the FOA so as to focus on different things, in some embodiments.

As would be appreciated, there may be hundreds of thousands or even millions of data points that need to be extracted at L₀. The DFRE's FOA is based on the abstraction and the DFRE knowledge graph (KG) may be used to keep combinatorial explosion under control.

Said differently, metamodel 700 may generally take the form of a knowledge graph in which semantic knowledge is stored regarding a particular system, such as a computer network and its constituent networking devices. By representing the relationships between such real-world entities (e.g., router A, router B, etc.), as well as their more abstract concepts (e.g., a networking router), DFRE agent 702 can make evaluations regarding the particular system at different levels of extraction. Indeed, metamodel 700 may differ from a more traditional knowledge graph through the inclusion of any or all of the following, in various embodiments:
A formal mechanism to represent different levels of abstraction, and for moving up and down the abstraction hierarchy (e.g., ranging from extension to intension).
Additional structure that leverages distinctions/anti-symmetric relations, as the backbone of the knowledge structures.
Similarity/symmetric relation-based relations.

Thus, DFRE metamodel 700 is a neuro-symbolic metamodel that leverages both sub-symbolic processing (e.g., using deep/neural networks) and symbolic reasoning. This allows it to perform zero-shot learning whereby it is able to make inferences about objects, behaviors, interactions, conditions, and the like, that are outside those on which it was specifically trained, as well as one-shot learning of class labels. For instance, say the system uses a seed ontology comprising the concepts of ‘standing’ and ‘running,’ but then encounters video data of a person walking. Even without specific knowledge about the concept of walking, the semantic reasoning engine may determine that this is an intermediate state between standing and running, based on the velocities involved, the pose analysis of the person, etc. This allows the system to learn different conditions and make inferences about situations that it may not have seen before.

As noted above, training a machine learning model is not an easy endeavor and is fraught with potential pitfalls. For this reason, the majority of artificial intelligence projects fail due to factors such as under specification of the problem, poor ability to generalize, expensive training cycles, and the like. In addition, even when an artificial intelligence model is deployed, it is unlikely to be optimized for its intended use.

### Artificial Intelligence Development and Upgrading Using a Neuro-Symbolic Metamodel

The techniques herein allow for the development and upgrading of artificial intelligence models using a neuro-symbolic metamodel, such as the one described above. In some aspects, the metamodel can be used to supervise existing artificial intelligence development workflows, to identify opportunities to improve performance, increase generality, and/or optimize the resulting model for the intended deployment environment.

Illustratively, the techniques described herein may be performed by hardware, software, and/or firmware, such as in accordance with the DFRE process 248, which may include computer executable instructions executed by the processor 220 (or independent processor of interfaces 210), to perform functions relating to the techniques described herein.

Specifically, according to various embodiments, a device obtains data regarding generation of an artificial intelligence model. The device analyzes the data using a neuro-symbolic metamodel, to match the data to one or more concepts of a knowledge graph of the neuro-symbolic metamodel. The device makes one or more inferences about the artificial intelligence model, by applying a semantic reasoning engine to the one or more concepts of the knowledge graph. The device causes, based on the one or more inferences, generation of a replacement artificial intelligence model for the artificial intelligence model.

Operationally, certain aspects of the techniques herein relate to leveraging the above neuro-symbolic metamodel architecture during the non-recurring engineering phase of the development of an artificial intelligence model, to identify opportunities to improve upon it. This zero-shot learning of underlying objects, behaviors, interactions, and so forth is further complimented via the one-shot learning of labels. In addition, the teacher system supports the addition of domain expert knowledge via a domain specific language.

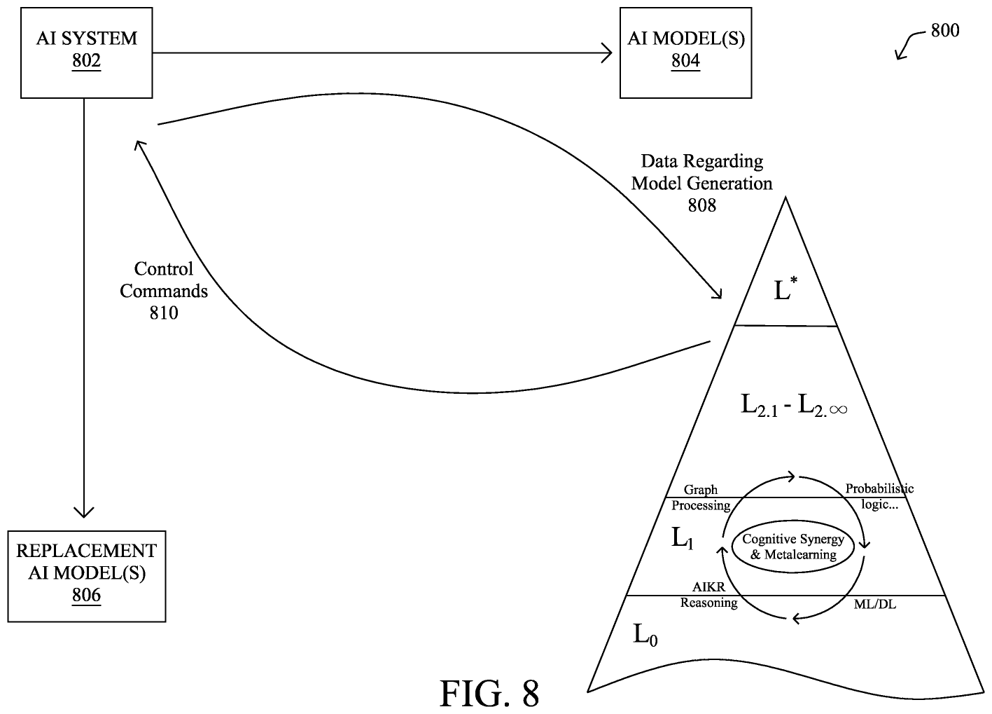

FIG. 8 illustrates an example 800 of using a DFRE metamodel to upgrade artificial intelligence models, according to various embodiments. As shown, assume that there is an artificial intelligence system 802 that is used to train one or more artificial intelligence models 804. For instance, artificial intelligence system 802 may take the form of a model training system, such as Tensorflow, Pytorch, or the like, or a system that incorporates such a model training system.

While a neuro-symbolic metamodel, such as DFRE metamodel 700 represents an evolution over existing artificial intelligence techniques, it is not yet feasible to replace all existing artificial intelligence deployments with a neuro-symbolic approach. This can be due to factors such as a lack of computational resources, a lack of expertise, etc. Regardless, many institutions may continue to rely on the creation of “AI 1.0” models, as opposed to an “AI 2.0” approach, such as those based on DFRE metamodel 700. For instance, an artificial intelligence model 804 may take the form of a (deep) neural network, random forest, clustering model, etc., or any other form of machine learning model. In other instances, an artificial intelligence model 804 may take the form of a semantic model that operates on symbolic data.

According to various embodiments, the techniques herein propose leveraging DFRE metamodel 700 to supervise the training process of artificial intelligence system 802 that results in artificial intelligence model(s) 804, to make inferences about the process and identify potential ways to optimize the resulting models. To this end, DFRE metamodel 700 may obtain data 808 regarding the generation of artificial intelligence model(s) 804. For instance, data 808 may include, but is not limited to, any or all of the following:
The training data used to generate model(s) 804
The type of training used to generate model(s) 804 (e.g., supervised, unsupervised, etc.)
The type of model(s) 804 (e.g., neural network, semantic model, etc.)
The class labels of model(s) 804, in the case of a classification model
The intended use of model(s) 804
The target deployment environment(s) of model(s) 804
The computational capabilities of the device(s) executing model(s) 804
The parameters of model(s) 804
The characteristics of model(s) 804 (e.g., number of nodes, layers, nodes per layer, etc.)
etc.

In various embodiments, DFRE metamodel 700 may match any or all of the above information to one or more concepts in its knowledge graph and, in turn, leverage its semantic reasoning engine to make inferences about the generation of model(s) 804. By way of example, consider the case in which a model 804 is intended to be deployed to a specific device for execution. In such a case, DFRE metamodel 700 may infer ways to train a minimally sized (in terms of total nodes, number of layers, nodes per layer, etc.) deep learning model to replace model(s) 804. In another embodiment, such as when model(s) 804 are semantic models, DFRE metamodel 700 may infer that a symbolic reasoning task of model 804 can be converted into a sub-symbolic, deep learning task (e.g., to take advantage of any hardware accelerators available on the deployment device).

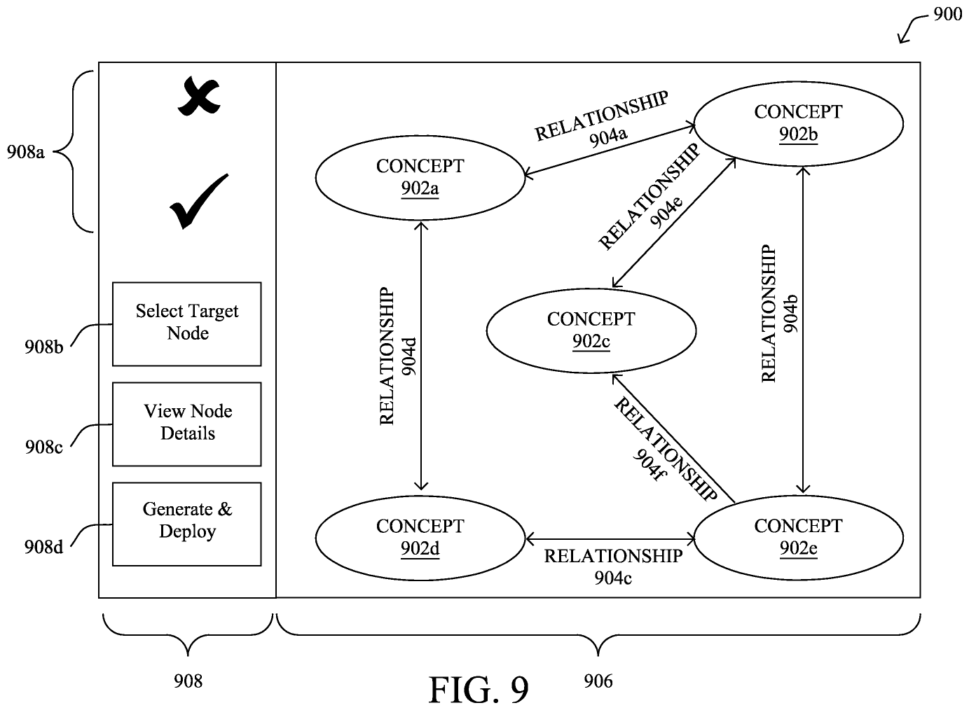

In some embodiments, a user may also be able to review and adjust the concepts and relationships relied upon by DFRE metamodel 700. For instance, FIG. 9 illustrates an example user interface 900 allowing a user to select which concepts are to be used by metamodel 700 when assessing the generation of artificial intelligence models, according to various embodiments. As shown, user interface 900 may include various inputs 908 that allow a user to interact with the system. For instance, user interface 900 may include a button or other input 1008b that allows the user to select a target node/device to which an artificial intelligence model is to be deployed. Once a node is selected, the user may interact with input 1008c, to review details about that node, such as its type, location in the network, capabilities, other functions, resource usage, or the like. In other instances, this information may be obtained through other means, such as from system 802 in FIG. 8.

In various embodiments, a key functionality of user interface 900 is to display information regarding the DFRE metamodel to a user, prior to its deployment to a target node. For instance, as shown, user interface 900 may display information 906 from the knowledge graph of the metamodel, such as its various concepts 902 (e.g., concepts 902a-902e) and their relationships (e.g., relationships 904a-904f). In one embodiment, the system may also indicate the importance of the various concepts 902 and their relationships 904. In other embodiments, user interface 900 may allow the user to specify their importance.

In further embodiments, user interface 900 may allow the user to edit the concepts 902 and their relationships 904, so as to tailor the concepts and relationships used by metamodel 700. For instance, the user may specify that concepts that should be used to perform the necessary object/behavior/interaction recognition with the required accuracy, robustness, and generalizability. Once the user is satisfied with their selections, they may opt to either accept or reject them via inputs 908a and, in turn, select input 908d to generate a replacement model based on these concepts.

Referring again to FIG. 8, once metamodel 700 has made one or more inferences about the generation of model(s) 804, it may cause system 802 to generate replacement model(s) 806 as replacements for model(s) 804, such as by sending control commands 810 to it. The output of this process is a model 806 that is a drop-in replacement for current model(s) 804, but with greatly improved ability to generalize, accuracy, etc. By way of example, assume that a model 804 is a classification model trained to detect vehicles within images. To improve the generalization of the model 804, DFRE metamodel 700 may assess the images in the training dataset and, in turn, command system 802 to perform training again using an altered training dataset, thereby resulting in a replacement model 806 that is better able to generalize (e.g., classify images that were previously unseen by the model). While the resulting replacement model 806 will not match the capabilities of a neuro-symbolic setup, such as DFRE metamodel 700, it will still represent a significant improvement over model(s) 804. Thus, the abstraction hierarchy of metamodel 700 may be transferred to replacement model(s) 806 with credible and explainable inductive biases.

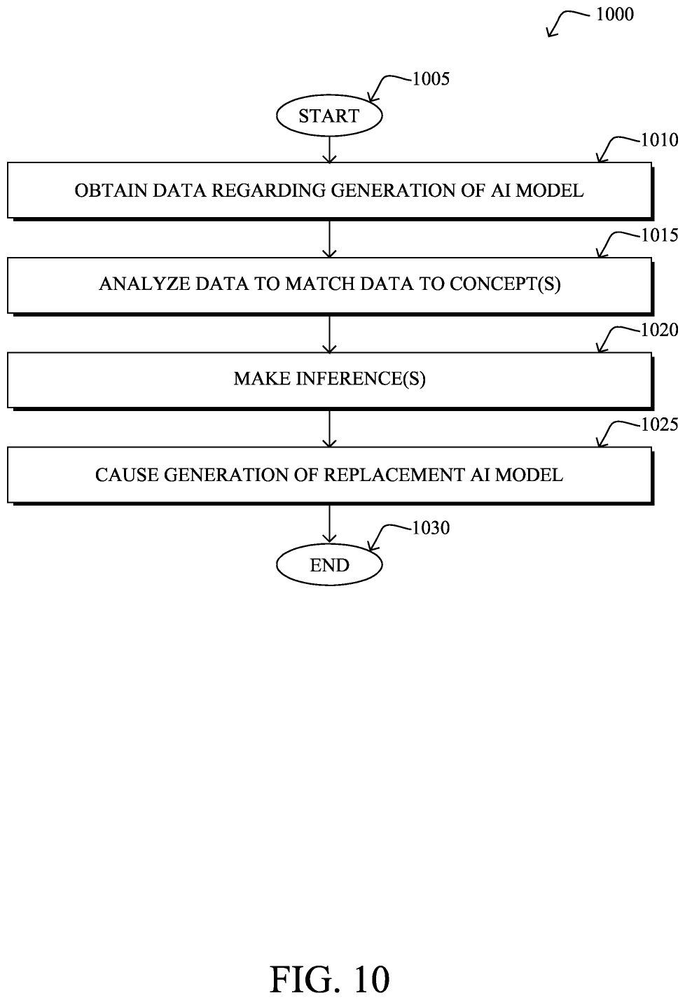

FIG. 10 illustrates an example simplified procedure (e.g., a method) for artificial intelligence development and upgrading using a neuro-symbolic metamodel, in accordance with one or more embodiments described herein. For example, a non-generic, specifically configured device (e.g., device 200) may perform procedure 1000 by executing stored instructions (e.g., DFRE process 248). The procedure 1000 may start at step 1005, and continues to step 1010, where, as described in greater detail above, the device may obtain data regarding generation of an artificial intelligence model. In one embodiment, the data regarding generation of the artificial intelligence model indicates a training environment in which the artificial intelligence model was trained, and wherein the one or more concepts relate to that training environment. In an additional embodiment, the data regarding generation of the artificial intelligence model comprises information regarding training data used to train the artificial intelligence model. In yet another embodiment, the data regarding generation of the artificial intelligence model comprises one or more class labels used by the artificial intelligence model.

At step 1015, as detailed above, the device may analyze the data using a neuro-symbolic metamodel, to match the data to one or more concepts of a knowledge graph of the neuro-symbolic metamodel. In some embodiments, the device may receive, via a user interface, an adjustment to the one or more concepts of the knowledge graph.

At step 1020, the device may make one or more inferences about the artificial intelligence model, by applying a semantic reasoning engine to the one or more concepts of the knowledge graph, as described in greater detail above. In one embodiment, the one or more inferences about the artificial intelligence model comprises an inference that it lacks generality or robustness, and wherein the replacement artificial intelligence model has greater generality or robustness than that of the artificial intelligence model. In other embodiments, the one or more inferences about the artificial intelligence model comprises an inference that it lacks accuracy, and wherein the replacement artificial intelligence model has greater accuracy than that of the artificial intelligence model. In some embodiments, the one or more inferences indicate that the training data should be altered when generating the replacement artificial intelligence model.

At step 1025, as detailed above, the device may cause, based on the one or more inferences, generation of a replacement artificial intelligence model for the artificial intelligence model. In one embodiment, the replacement artificial intelligence model comprises a deep learning model. In some embodiments, the conversion may entail converting a symbolic reasoning task of the artificial intelligence model into a deep learning task in the replacement artificial intelligence model. In some embodiments, the replacement artificial intelligence model has fewer total nodes, layers, or nodes per layer than that of the artificial intelligence model. Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for artificial intelligence development and upgrading using a neuro-symbolic metamodel, it is to be understood that various other adaptations and modifications may be made within the spirit and scope of the embodiments herein. For example, while certain embodiments are described herein with respect to specific types of artificial intelligence development systems, the techniques can be extended without undue experimentation to other use cases, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a device, data regarding generation of an artificial intelligence model;
analyzing, by the device, the data using a neuro-symbolic metamodel, to match the data to one or more concepts of a knowledge graph of the neuro-symbolic metamodel;
making, by the device, one or more inferences about the artificial intelligence model, by applying a semantic reasoning engine to the one or more concepts of the knowledge graph; and
causing, by the device and based on the one or more inferences, generation of a replacement artificial intelligence model for the artificial intelligence model.

2. The method as in claim 1, wherein the replacement artificial intelligence model comprises a deep learning model.

3. The method as in claim 1, wherein the one or more inferences about the artificial intelligence model comprises an inference that it lacks generality or robustness, and wherein the replacement artificial intelligence model has greater generality or robustness than that of the artificial intelligence model.

4. The method as in claim 1, wherein the one or more inferences about the artificial intelligence model comprises an inference that it lacks accuracy, and wherein the replacement artificial intelligence model has greater accuracy than that of the artificial intelligence model.

5. The method as in claim 1, further comprising:
receiving, at the device and via a user interface, an adjustment to the one or more concepts of the knowledge graph.

6. The method as in claim 1, wherein causing generation of the replacement artificial intelligence model for the artificial intelligence model comprises:
converting a symbolic reasoning task of the artificial intelligence model into a deep learning task in the replacement artificial intelligence model.

7. The method as in claim 1, wherein the data regarding generation of the artificial intelligence model indicates a training environment in which the artificial intelligence model was trained, and wherein the one or more concepts relate to that training environment.

8. The method as in claim 1, wherein the replacement artificial intelligence model has fewer total nodes, layers, or nodes per layer than that of the artificial intelligence model.

9. The method as in claim 1, wherein the data regarding generation of the artificial intelligence model comprises information regarding training data used to train the artificial intelligence model, and wherein the one or more inferences indicate that the training data should be altered when generating the replacement artificial intelligence model.

10. The method as in claim 1, wherein the data regarding generation of the artificial intelligence model comprises one or more class labels used by the artificial intelligence model.

11. An apparatus, comprising:
a network interface to communicate with a computer network;
a processor coupled to the network interface and configured to execute one or more processes; and
a memory configured to store a process that is executed by the processor, the process when executed configured to:
obtain data regarding generation of an artificial intelligence model;
analyze the data using a neuro-symbolic metamodel, to match the data to one or more concepts of a knowledge graph of the neuro-symbolic metamodel;
make one or more inferences about the artificial intelligence model, by applying a semantic reasoning engine to the one or more concepts of the knowledge graph; and
cause, based on the one or more inferences, generation of a replacement artificial intelligence model for the artificial intelligence model.

12. The apparatus as in claim 11, wherein the replacement artificial intelligence model comprises a deep learning model.

13. The apparatus as in claim 11, wherein the one or more inferences about the artificial intelligence model comprises an inference that it lacks generality or robustness, and wherein the replacement artificial intelligence model has greater generality or robustness than that of the artificial intelligence model.

14. The apparatus as in claim 11, wherein the one or more inferences about the artificial intelligence model comprises an inference that it lacks accuracy, and wherein the replacement artificial intelligence model has greater accuracy than that of the artificial intelligence model.

15. The apparatus as in claim 11, wherein the process when executed is further configured to:
receive, via a user interface, an adjustment to the one or more concepts of the knowledge graph.

16. The apparatus as in claim 11, wherein the apparatus causes generation of the replacement artificial intelligence model for the artificial intelligence model by:
converting a symbolic reasoning task of the artificial intelligence model into a deep learning task in the replacement artificial intelligence model.

17. The apparatus as in claim 11, wherein the data regarding generation of the artificial intelligence model indicates a training environment in which the artificial intelligence model was trained, and wherein the one or more concepts relate to that training environment.

18. The apparatus as in claim 11, wherein the replacement artificial intelligence model has fewer total nodes, layers, or nodes per layer than that of the artificial intelligence model.

19. The apparatus as in claim 11, wherein the data regarding generation of the artificial intelligence model comprises information regarding training data used to train the artificial intelligence model, and wherein the one or more inferences indicate that the training data should be altered when generating the replacement artificial intelligence model.

20. A tangible, non-transitory, computer-readable medium storing program instructions that cause a device to execute a process comprising:
obtaining, by the device, data regarding generation of an artificial intelligence model;
analyzing, by the device, the data using a neuro-symbolic metamodel, to match the data to one or more concepts of a knowledge graph of the neuro-symbolic metamodel;
making, by the device, one or more inferences about the artificial intelligence model, by applying a semantic reasoning engine to the one or more concepts of the knowledge graph; and
causing, by the device and based on the one or more inferences, generation of a replacement artificial intelligence model for the artificial intelligence model.
